(19) United States
(12) Patent Application Publication
(10) Pub. No.: US 2019/0217322 A1
(43) Pub. Date: Jul. 18, 2019

(54) PUMP DEVICE FOR A FLUID CONTAINER

(71) Applicant: ALUAIR GMBH, Baar (CH)

(72) Inventors: Johannes Hubertus Jozef Maria KELDERS, Baar (CH); Roland KNAUER, Baar (CH); Jürgen KLOEBBE, Baar (CH)

(73) Assignee: AluAir GmbH, Baar (CH)

(21) Appl. No.: 16/317,650

(22) PCT Filed: Jul. 12, 2017
(86) PCT No.: PCT/IB2017/054222

§ 371 Date: Jan. 14, 2019

(30) Foreign Application Priority Data
Jul. 12, 2016 (CH) 00887/16

(51) Int. Cl. B05B 15/50; B05B 11/00

(52) U.S. Cl. CPC B05B 15/50; B05B 11/3023; B05B 11/0072

(57) ABSTRACT

The invention relates to a novel pump device for a fluid container for dispensing a fluid, which device has an operating element and a head part, wherein a piston-cylinder unit forming a pump chamber is provided between the operating element and the head part. An inlet valve is provided at the inlet of the pump chamber, and an outlet valve is provided at the outlet of the pump chamber, wherein the operating element has an outflow with an outflow opening. The outlet valve is also provided at the outflow, and the outflow opening forms a valve seat in such a way that the outlet valve closes the outlet opening from outside.

### CROSS-REFERENCE TO RELATED APPLICATIONS

This application is a National Stage application of International Patent Application No. PCT/IB2017/054222 filed Jul. 12, 2017, which claims priority to Swiss Patent Application No. 00887/16, filed Jul. 12, 2016, each of which is hereby incorporated by reference in its entirety.

### TECHNICAL FIELD

The invention relates to a pump device for a fluid container for dispensing a fluid.

### BACKGROUND OF THE INVENTION

Pump devices for a fluid container for dispensing a fluid, such as liquid or foam, are known in general. A pump device of this kind has a head part which is fastened to a fluid container, and an operating element, which is pushed upwardly by a spring element between the operating element and the head part. Furthermore, a piston is provided on the operating element and a cylinder is provided on the head part, and these form a pump chamber. An inlet valve is provided for the inlet into the pump chamber and an outlet valve is provided for the outlet from the pump chamber. An outflow is also provided on the operating element in order to dispense the fluid.

A pump device of this kind for dispensing a fluid is known for example from WO-A-2012/168916. In that case the operating element has an outflow and first cylinder element and the head part has a second cylinder element, which is arranged so as to be movable back and forth coaxially relative to the first cylinder element. A folded resilient diaphragm with an inlet valve and an outlet valve is mounted between the first cylinder element and the second cylinder element so that the two cylinder elements and the resilient diaphragms form a pump chamber. The outlet valve is arranged slidingly on the outer wall of the first cylinder element and the outflow. A suck-back chamber is formed between the outlet valve and the outflow, which chamber has a variable volume and is reduced and enlarged simultaneously with the pump movement of the pump chamber. The outflow of the pump device can thus be kept free from excess fluid (liquid, foam).

The suck-back suction chamber, however, still has a certain residual volume when the operating element is pushed down, and therefore although fluid is indeed suctioned away completely from the outflow as the suck-back chamber enlarges, a small amount of residual fluid remains above the outlet valve. This residual amount is then connected to the outside air via the outflow. In the case of easily perishable fluids or liquids, such as milk or certain creams, this residual amount of fluid can perish and then contaminate the fluid to be dispensed from the pump chamber. The outflow may thus also become clogged.

There are a large number of patent documents in which the problem of clogging of the outflow is solved by providing an outlet valve at the end of the outflow. The outflow has an outflow opening with a smaller diameter than the outflow, and the outflow opening is opened and closed by a closure from inside the outflow channel. The outflow opening opens out in a conically discharging funnel, in which residual amounts of fluid to be dispensed may still remain. Examples of a closure of this kind are described in U.S. Pat. No. 6,543,703 B2 or in EP 2 310 142 B1.

### SUMMARY OF THE INVENTION

The object of the present invention is to develop a pump device in which contamination by perished fluid is prevented to the greatest possible extent.

This object is achieved by a pump device for a fluid container for dispensing a fluid, which device has an operating element and a head part, wherein a piston-cylinder unit forming a pump chamber is provided between the operating element and the head part, and an inlet valve is provided at the inlet of the pump chamber, and an outlet valve is provided at the outlet of the pump chamber, wherein the operating element has an outflow with an outflow opening, characterised in that the outlet valve is provided at the outflow, and the outflow opening forms a valve seat in such a way that the outlet.

The pump device according to the invention for a fluid container for dispensing a fluid has an operating element and a head part, wherein a piston cylinder unit forming a pump chamber is provided between the operating element and the head part. An inlet valve is provided at the inlet of the pump chamber and an outlet valve is provided at the outlet of the pump chamber, wherein the operating element has an outflow with an outflow opening. The outlet valve is provided here at the outflow, and the outflow opening forms a valve seat in such a way that the outlet valve closes the outlet opening from outside.

In accordance with an aspect of the present invention, the outlet valve is advantageously formed by a resilient second spring element acting as a tension spring and having a sealing stopper, wherein the sealing stopper closes the outflow opening from outside, and the inner end of the second spring element is fastened to the inner wall of the outflow.

In accordance with another aspect of the present invention, an inwardly projecting protrusion is preferably provided on the inner wall, with the inner end region of the second spring element being fastened to said protrusion.

In another advantageous embodiment of the present invention, a sealing sleeve is arranged in the outflow, flush with the outlet opening, with the second spring element being fastened to said sleeve.

The sealing sleeve and the second spring element can be connected to one another in one piece.

The sealing stopper preferably has a mushroom-shaped head with a conical closure part, and the valve seat is formed conically, accordingly.

The sealing stopper can be formed as a hard plastic part, and the sealing sleeve and/or the second spring element can be formed from a soft plastic.

On the other hand, the sealing stopper can have an inner part made of hard plastic and a coating made of soft plastic.

The sealing stopper can also be provided with a protuberance which is received in a blind bore-like recess in the second spring element.

The head part can be suitable for fastening to the fluid container, and a resilient diaphragm can form a first spring element between the operating element and the head part so as to push the operating element away from the head part.

The piston-cylinder unit is advantageously formed by a first cylinder, which is fastened to the operating element from therebeneath, and by a second cylinder, which is fastened to the head part from thereabove, coaxially with the first cylinder.

The first cylinder can also comprise the second cylinder with a cylindrical gap, and the first cylinder can be provided with an inwardly projecting closed cylinder part which is surrounded by the second cylinder with a cylindrical gap.

The resilient diaphragm is preferably formed cylindrically with an elbowed lower end and a hook-shaped upper end, wherein the diaphragm is arranged between the first and second cylinder in such a way that the elbowed lower end grasps around the second cylinder and the hook-shaped upper end is supported on the free end of the first cylinder.

Further advantages of the invention will emerge from the claims and from the following description, in which the invention is explained in greater detail on the basis of an exemplary embodiment shown in the schematic drawings.

### BRIEF DESCRIPTION OF THE INVENTION

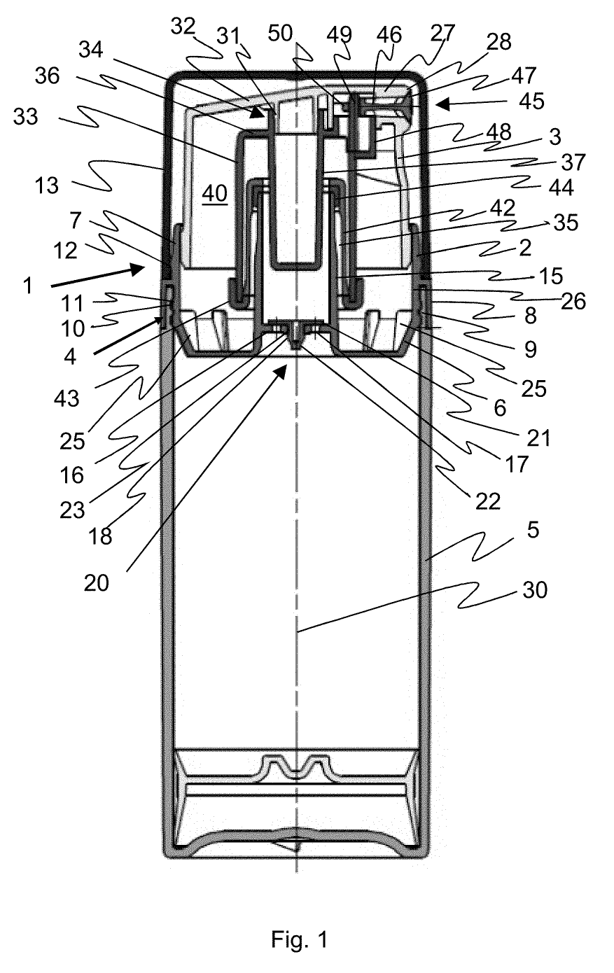

FIG. 1 shows a pump device for a fluid container;

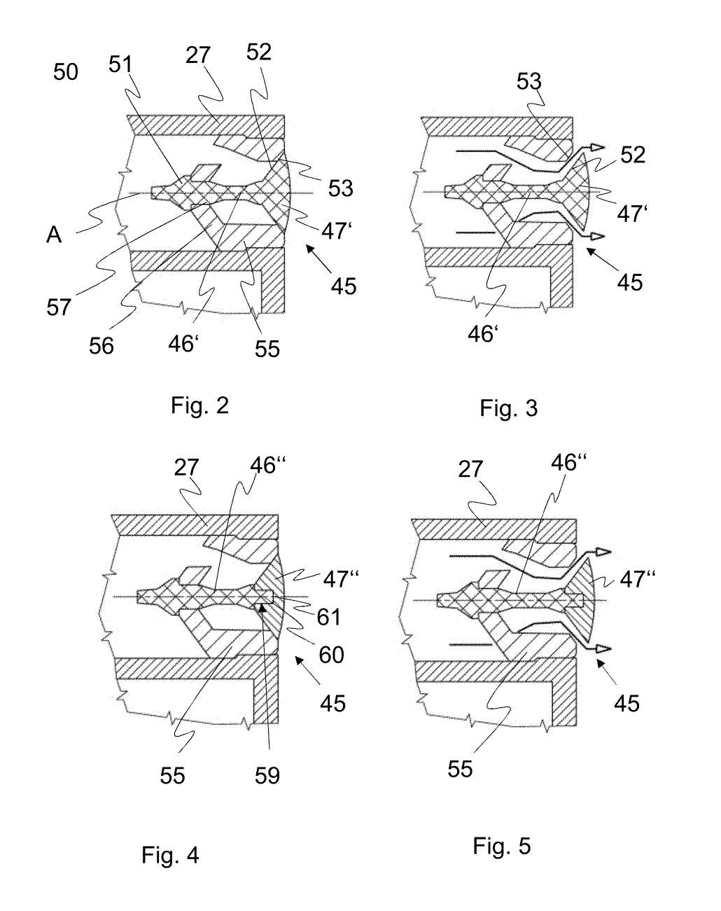

FIGS. 2 and 3 show a first embodiment of the outlet valve in cross section;

FIGS. 4 and 5 show a second embodiment of the outlet valve in cross section;

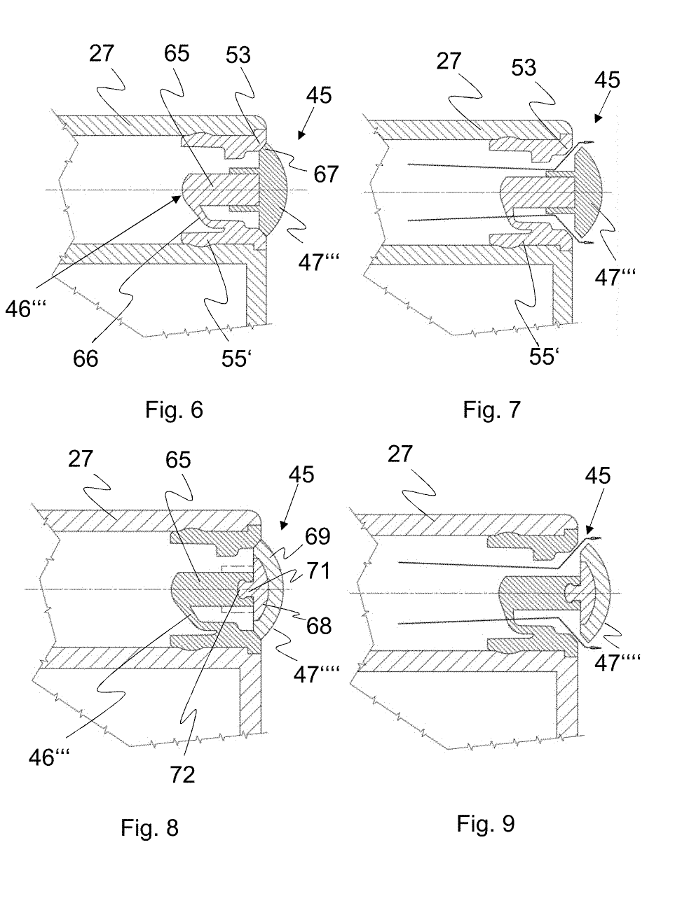

FIGS. 6 and 7 show a third embodiment of the outlet valve in cross section;

FIGS. 8 and 9 show a fourth embodiment of the outlet valve in cross section;

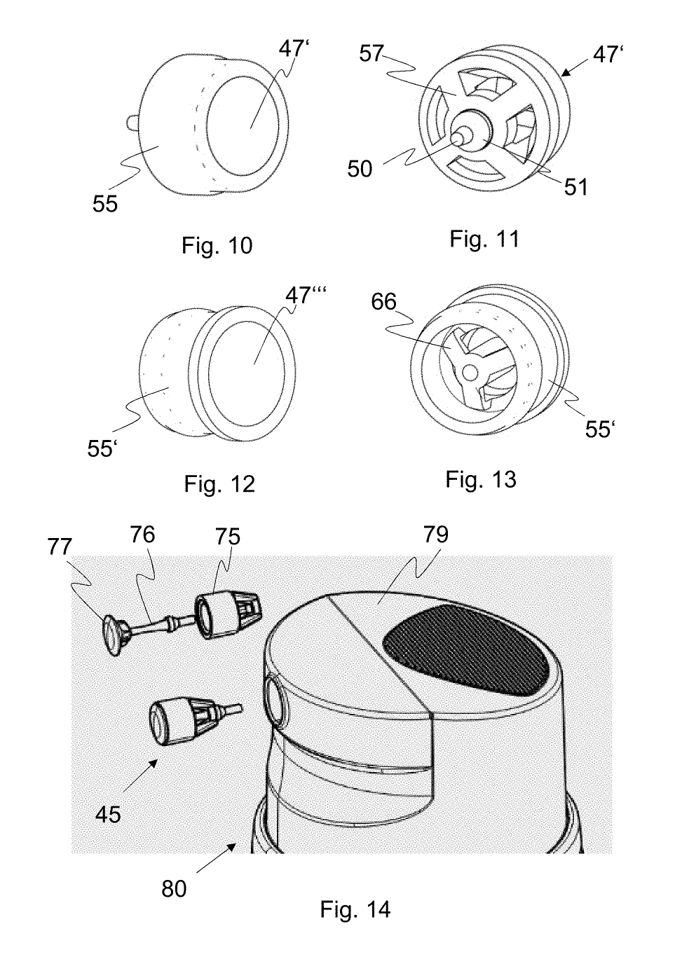

FIGS. 10 and 11 show a perspective illustration of the sealing sleeve and of the sealing stopper of the outlet valve.

### DETAILED DESCRIPTION OF THE INVENTION

In the figures, the same reference signs are used for the same elements, unless stated otherwise.

FIG. 1 shows a pump device 1 which has a head part 2 and an operating element 3. The head part 2 is fastened to a fluid container 5 by means of a clamping closure 4. The head part 2 is formed as a cylindrical beaker with a conically beveled base 6 and a ring-cylindrical, upright side wall 7. A projecting ring-cylindrical clamping edge 8 is provided approximately in the middle of the side wall 7 and is clamped on the upper edge 9 of the fluid container 5. The clamping connection is ensured by annular springs 10 and annular grooves 11. An annular bead 12 is also provided above the clamping edge 8 so as to securely clamp a beaker-shaped cap 13. The head part 2 also has a first, upwardly projecting cylinder 15 in the middle, which cylinder, in the lower region, has a perforated plate 16 with bores 17 arranged in a circle and at regular distances from one another. The perforated plate 16 is integral with the wall of the first cylinder 15. A central bore 18 is also provided in the perforated plate 16, in which bore there is provided an inlet valve 20. The inlet valve 20 consists of an upper plate 21, which covers the bores 17, and a downwardly conically closed tube 22, which has a ring-cylindrical flat indentation 23 on the outer wall. The inlet valve 20 is thus trapped in the central bore 18, but can make a minimal movement up and down in order to open and close the valve. At the base 6, wings 25 are provided on the inner wall 26 of the head part 2, which wings are distributed at regular distances from one another on the inner side and delimit the stroke of the operating element 3.

The operating element 3 is formed as a cylindrical cap and has, laterally, an outflow 27 with an outflow opening 28. An annular sleeve 31 is mounted on the roof 32 of the operating element 2 centrally to the axis of symmetry 30 and is used to fasten a second cylinder 33 to the operating element 2 by means of a clamping connection 34. The second cylinder 33 has a greater diameter than the first cylinder 15, such that a ring-cylindrical gap 35 exists between said cylinders. The second cylinder 33 is also closed at the top by a base 36, on which there is provided an inwardly projecting, closed cylinder part 37, The cylinder part 37 used as a piston and the second cylinder 33 thus form a piston-cylinder unit 40.

A resilient diaphragm 42 is provided as first spring element between the first cylinder 15 and the second cylinder 33 and is provided with a beveled lower end 43 and a hook-shaped upper end 44. The beveled lower end 43 is formed by a plastic ring, whereas the resilient diaphragm 42 is formed from an elastomer. The upper hook-shaped end 44 is formed by a folded plastic ring.

An outlet valve 45 is mounted at the outflow opening 28 and covers the outflow opening 28 flushly in the closed state. The outlet valve 45 is formed by a resilient, second spring element 46 acting as a tension spring and having a sealing stopper 47. The second cylinder 33 also has, in the region of the outflow 27, a cylindrical connection piece 48 with an intermediate wall or protrusion 49 projecting upwardly centrally, which protrusion is used to fasten the free end region 50 of the second spring element 46, such that this is clamped between the sealing stopper 47 and the end 50, and the outlet valve 45 closes the outflow opening in an air-tight and liquid-tight manner.

Instead of a diaphragm as spring element, a conventional compression spring can also be provided between the operating element 3 and the head part 2. The piston-cylinder unit can also be formed in the manner known per se.

FIGS. 2 and 3 show a first embodiment of the outlet valve 45 with a mushroom-shaped sealing stopper 47′ and a second spring element 46′, which at the end region 50 has a step-shaped widening 51. The second spring element 46′ and the sealing stopper 47′ are produced from a soft resilient plastic. The sealing stopper 47′ has a conical closure part 52, which fits in a corresponding conical valve seat 53 of the outflow 27. A sealing sleeve 55 made of a hard plastic is also provided in the outflow 27 and is provided with an inwardly projecting protrusion 56 with a bore 57 arranged on the longitudinal axis A of the outflow 27.

As the pressure on the fluid to be dispensed is increased, this being brought about by the pump movement of the pump device 1, the second spring element 46′ expands and the outlet valve 45 is opened (see FIG. 3), and therefore the fluid can flow outwardly along the sealing stopper 47′. If the pressure drops, the outlet valve 45 is closed again. The outlet valve 45 thus closes the outlet opening 28 from outside.

FIGS. 4 and 5 show a second embodiment of the outlet valve 45, wherein the second spring element 46″ and the sealing stopper 47″ are individual parts. In this case the front end 59 of the spring element 46″ is provided with a protuberance 60, which is pressed in a blind bore 61 of the sealing stopper 47″. The spring element 46″ is produced here from a soft resilient plastic, and the sealing stopper 47″ is produced from a hard plastic.

FIGS. 6 and 7 show a third embodiment of the outlet valve 45 in the closed and open state, wherein here the sealing sleeve 55′ is integral with the second spring element 46′″. The spring element 46′″ consists here of a central circular-cylindrical fastening part 65 and a plurality of spring legs 66, which are moulded on the inner wall of the sealing sleeve 55. The sealing stopper 47′″ is likewise mushroom-shaped here, but has just one conical edge 67 towards the conical valve seat 53. The sealing stopper 47′″ also has an inner fastening sleeve 68, which is pressed on the fastening part 65. The spring legs 66 bring about the necessary pretension in order to press the sealing stopper 47′″ into the valve seat 53. The second spring element 46′″ is produced from a soft resilient plastic and the sealing stopper 47′″ is produced from a hard plastic.

FIGS. 8 and 9 show a fourth embodiment of the outlet valve 45, similar to the embodiment of FIGS. 6 and 7, wherein the sealing stopper 47″″ is now formed in two parts from an inner part 68 made of hard plastic and a coating 69 made of a soft plastic. The sealing stopper 47″″ has a protuberance 71, which is pressed into a corresponding blind bore or a blind bore-like recess 72 in the fastening part 65. The sealing stopper 47″″ is produced in a two-component injection moulding process.

FIGS. 10 and 11 are a perspective illustration of the first and second embodiment according to FIGS. 2 and 3 and FIGS. 4 and 5.

FIGS. 12 and 13 are a perspective illustration of the third and fourth embodiment according to FIGS. 6 and 7 and FIGS. 8 and 9.

FIG. 14 shows a fifth embodiment of the outlet valve 45 in a perspective illustration, which outlet valve consists of a sealing sleeve 75 with a second spring element 76 and a sealing stopper 76, which in the assembled state is introduced into the outlet 77 of the head part 78 of a fluid pump 79 in a press fit.

While the present disclosure has been illustrated and described with respect to a particular embodiment thereof, it should be appreciated by those of ordinary skill in the art that various modifications to this disclosure may be made without departing from the spirit and scope of the present disclosure.

What is claimed is:

1. A pump device for a fluid container for dispensing a fluid, which device has an operating element and a head part, wherein a piston-cylinder unit forming a pump chamber is provided between the operating element and the head part, and an inlet valve is provided at the inlet of the pump chamber, and an outlet valve is provided at the outlet of the pump chamber, wherein the operating element has an outflow with an outflow opening, wherein the outlet valve is provided at the outflow, and the outflow opening forms a valve seat in such a way that the outlet valve doses the outlet opening from outside.

2. The pump device according to claim 1, wherein the outlet valve is formed by a resilient second spring element acting as a tension spring and having a sealing stopper, wherein the sealing stopper closes the outflow opening from outside, and the inner end of the second spring element is fastened to the inner wall of the outflow.

3. The pump device according to claim 2, wherein an inwardly projecting protrusion is provided on the inner wall, with the inner end region of the second spring element being fastened to said protrusion.

4. The pump device according to claim 2, wherein a sealing sleeve is arranged in the outflow, flush with the outlet opening, with the second spring element being fastened to said sleeve.

5. The pump device according to claim 4, wherein the sealing sleeve and the second spring element are connected to one another in one piece.

6. The pump device according to claim 2, wherein the sealing stopper has a mushroom-shaped head with a conical closure part, and the valve seat is conical, accordingly.

7. The pump device according to claim 6, wherein the sealing stopper is formed as a hard plastic part and the sealing sleeve and/or the second spring element are/is formed from a soft plastic.

8. The pump device according to claim 7, wherein the sealing stopper has an inner part made of hard plastic and a coating made of soft plastic.

9. The pump device according to claim 8, wherein the sealing stopper is provided with a protuberance, which is received in a blind bore-like recess in the second spring element.

10. The pump device according to claim 1, wherein the head part is suitable for fastening to the fluid container, and a resilient diaphragm forms a first spring element between the operating element and the head part in order to press the operating element away from the head part.

11. The pump device according to claim 10, wherein the piston-cylinder unit is formed by a first cylinder, which is fastened to the operating element from therebeneath, and by a second cylinder, which is fastened to the head part from thereabove, coaxially with the first cylinder.

12. The pump device according to claim 11, wherein the first cylinder comprises the second cylinder with a cylindrical gap, and the first cylinder is provided with an inwardly projecting closed cylinder part which is surrounded by the second cylinder with a cylindrical gap.

13. The pump device according to claim 10, wherein the resilient diaphragm is formed cylindrically with a beveled lower end and a hook-shaped upper end, wherein the diaphragm is arranged between the first and second cylinder in such a way that the beveled lower end grasps around the second cylinder and the hook-shaped upper end is supported at the free end of the first cylinder.
